(19) United States
(12) Patent Application Publication
(10) Pub. No.: US 2016/0379369 A1
(43) Pub. Date: Dec. 29, 2016

(54) WIRELESS AIRCRAFT AND METHODS FOR OUTPUTTING LOCATION INFORMATION OF THE SAME

(71) Applicant: OPTiM Corporation, Saga (JP)

(72) Inventor: Shunji SUGAYA, Tokyo (JP)

(21) Appl. No.: 15/185,094

(22) Filed: Jun. 17, 2016

(30) Foreign Application Priority Data
Jun. 29, 2015 (JP) 2015-130293

(51) Int. Cl. G06T 7/00; B64D 45/00; B64D 47/08; B64C 39/02; G06K 9/00; G06K 9/62

(52) U.S. Cl. CPC G06T 7/0044; G06K 9/0063; G06K 9/6215; G06K 9/00369; B64D 47/08; B64C 39/024; B64D 45/00; B64C 2201/00

(57) ABSTRACT

The present invention is to provide a wireless aircraft and a method for outputting location information to reduce a cost, simplify the process, and output the necessary information. The wireless aircraft 10 flying in the air takes an live image, detects the location information on which the wireless aircraft is located, stores a specific image of an extracted object, compares the taken live image with the specific image to recognize an object to be extracted from the live image, and outputs the detected location information when the object is recognized.

### CROSS REFERENCE TO RELATED APPLICATIONS

This application claims priority to Japanese Patent Application No. 2015-130293 filed on Jun. 29, 2015, the entire contents of which are incorporated by reference herein.

### TECHNICAL FIELD

The present invention relates to a wireless aircraft flying in the air and a method for outputting location information.

### BACKGROUND ART

A wireless aircraft flying in the air with a propeller that rotates by the motor has been put to practical use in recent years. Such a wireless aircraft is used to take an image such as moving and still images.

A wireless aircraft takes an image from height and performs image analysis on the taken image.

Moreover, apart from the wireless aircraft, it is generally performed that when a user wearing an image capturing device encounters a danger, the image of the place is transmitted to a center along with the location information, and when another user wearing an information display device approaches this place, information such as an image of a dangerous place is delivered to the user. (Refer to Patent Document 1)

### CITATION LIST

### Patent Literature

Patent Document 1: JP 2015-41969A

### SUMMARY OF INVENTION

Patent Document 1 describes that the center acquires the location information of each user's information display device and if judging that the acquired location information on a user's information display device is matched with location information on a dangerous place which has been transmitted from an image capturing device, the information such as an image of the dangerous place is transmitted to the user's information display device.

However, in the method described in Patent Document 1, the cost of the entire system increases as the image capturing device needs to transmit the location information to the center, and the process might become complicated as whether or not it is dangerous is judged based on the biological information.

Therefore, in the present invention, the inventor has paid attention that a cost can be reduced, a process is simplified, and the necessary information can be output by a wireless aircraft which takes an image, performs image recognition on the taken image, and transmits the location information of the taken image to the terminal.

Accordingly, an objective of the present invention is to provide a wireless aircraft and a method for outputting location information to reduce a cost, simplify the process, and output the necessary information.

The first aspect of the present invention provides a wireless aircraft flying in the air, including:

a camera unit that takes a live image;

a location information detecting unit that detects the location information on which the wireless aircraft is located;

a specific image storage unit that stores a specific image of an extracted object;

an object recognition unit that compares the live image taken by the camera unit with the specific image to recognize an object to be extracted from the live image; and

a location information output unit that outputs the location information detected by the location information detecting unit when the object is recognized.

According to the first aspect of the present invention, the wireless aircraft flying in the air takes a live image, detects the location information on which the wireless aircraft is located, stores a specific image of an extracted object, compares the live image taken by the camera unit with the specific image to recognize an object to be extracted from the live image, and outputs the location information detected by the location information detecting unit when the object is recognized.

The first aspect of the invention belongs to the category of a wireless aircraft but has the same working effects under different categories such as a method for outputting location information.

The second aspect of the present invention provides the wireless aircraft according to the first aspect of the present invention, including a device activating unit that activates a predetermined device according to the type of the specific image when the wireless aircraft moves to the position in which the location information was output.

According to the second aspect of the present invention, the wireless aircraft according to the first aspect of the present invention activates a predetermined device according to the type of the specific image when the wireless aircraft moves to the position in which the location information was output.

The third aspect of the present invention provides a method for outputting the location information performed by the wireless aircraft flying in the air includes the steps of;

taking a live image;

detecting the location information on which the wireless aircraft is located;

storing a specific image of an extracted object;

comparing the live image taken by the camera unit with the specific image to recognize an object to be extracted from the live image; and

outputting the detected location information when the object is recognized.

The present invention can provide a wireless aircraft and a method for outputting location information to reduce a cost, simplify the process, and output the necessary information.

### BRIEF DESCRIPTION OF DRAWINGS

FIG. 1 shows an overview of the location information output system 1.

FIG. 2 shows an overall schematic diagram of the location information output system 1.

FIG. 3 is a functional block diagram of the wireless aircraft 10 and the portable terminal 100.

FIG. 4 is a flow chart of the location information output process executed by the wireless aircraft 10 and the portable terminal 100.

FIG. 5 is a flow chart of the countermeasure process executed by the wireless aircraft 10.

FIG. 6 shows the image data table that the wireless aircraft 10 stores.

FIG. 7 shows the imaging target area 3 on which the wireless aircraft 10 takes an image.

FIG. 8 shows the location information table that wireless aircraft 10 stores.

FIG. 9 shows the countermeasure information table that wireless aircraft 10 stores.

FIG. 10 shows the farm products map that the portable terminal 100 displays.

### DESCRIPTION OF EMBODIMENTS

Preferred embodiments of the present invention are described below with reference to the attached drawings. However, this is illustrative only, and the scope of the present invention is not limited thereto.

### Overview of Location Information Output System 1

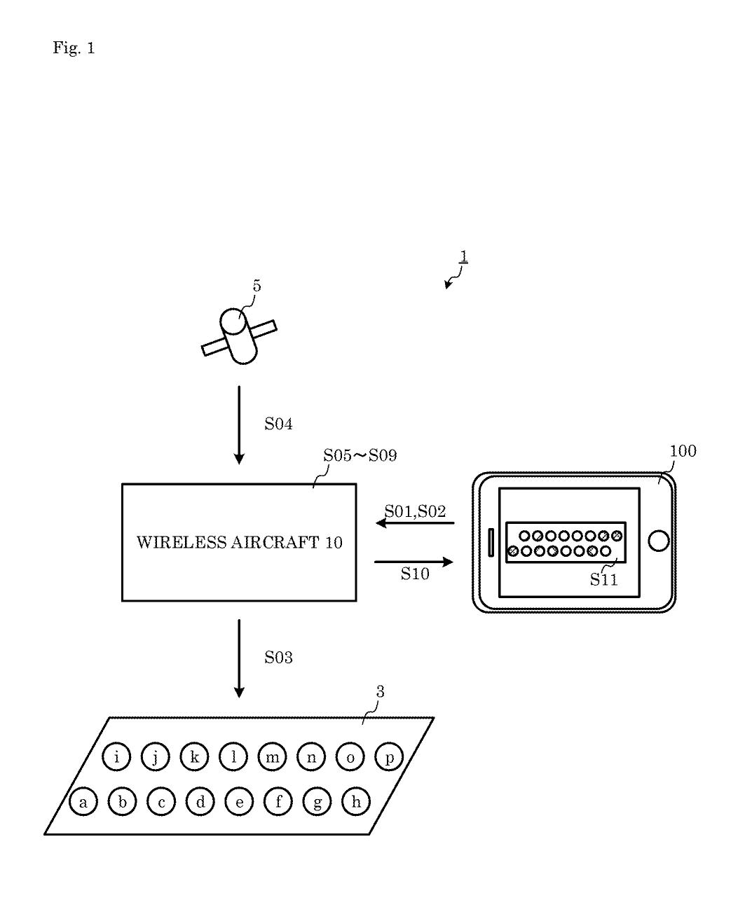

FIG. 1 shows an overview of the location information output system 1 according to a preferred embodiment of the present invention. The location information output system 1 includes an imaging target area 3, a GPS system 5, a wireless aircraft 10, and a portable terminal 100.

The wireless aircraft 10 flies in the air with the propeller, etc., of its own. Moreover, the wireless aircraft 10 is a wireless aircraft which is capable of remote control from an external terminal such as the portable terminal 100 or other operational terminals and automatic control based on the predetermined action which is programmed in it. Moreover, the wireless aircraft 10 includes the data communication functions for transmitting the taken image data, its own location information, and other data, etc., to the portable terminal 100, and receiving the data, etc., transmitted from the portable terminal 100.

The wireless aircraft 10 includes a camera, etc., that takes the moving and still images of the current status of the imaging target area 3 as a live image. Moreover, the wireless aircraft 10 detects and acquires its own location information from the GPS system 5. Moreover, the wireless aircraft 10 includes a memory unit that stores a specific image of the extracted object. Examples of the extracted objects are a farm product and a person. Examples of the specific image of the extracted objects are size, shape, color, and irregularity in case of a farm product, and age, sex, and costume in case of a person. Moreover, the wireless aircraft 10 compares a live image with a specific image to recognize an object to be extracted from the live image. The objects to be extracted are size, shape, color, and irregularity of the farm products, or age, sex, and costume of the person included in the live image. The wireless aircraft 10 includes the data communication functions that transmit the location information of its own acquired from the GPS system 5 to the portable terminal 100 when it has recognized the object. Moreover, the wireless aircraft 10 includes a device activating unit that activates a predetermined device according to the type of the specific image when moved back to the previous position in which the location information was output. Examples of the activation of the predetermined device is a chemical spraying for the harvest of the crops or for exterminating the pests and diseases in case of the farm products or a distribution of handbills depending on the sex or assistance including route guidance in case of a person.

The user terminal 100 is a home or an office appliance with a data communication function and performing a data communication with the wireless aircraft 10. Examples of the mobile terminal 100 includes information appliances such as a mobile phone, a mobile terminal, a personal computer, a net book terminal, a slate terminal, an electronic book terminal, and a portable music player.

In this embodiment, the imaging target area 3 is a place such as a field where farm products are grown, and the grown farm products are a-p. Moreover, the extracted object is a farm product. The specific image is an image of the farm products for determining the appropriate harvest time. Moreover, the information recognized as extracted objects are size, shape, color, and irregularity of the farm products. Moreover, the activation of the predetermined device is a chemical spraying for the harvest of the crops or for exterminating the pests and diseases.

Moreover, the imaging target area 3, the extracted object, the specific image, the information recognized as extracted object, and the activation of the predetermined device may be changed as appropriate. Furthermore, the imaging target area 3, the extracted object, the specific image, the information recognized as extracted object, and the activation of the predetermined device may be other than the farm products. For example, when the imaging target area 3 is crowded place, the extracted object is a person, the specific image is a person who is appropriate for the predetermined conditions, the information recognized as extracted objects are age, sex, and costume of a person, and the activation of the predetermined device may be an activation of a device that distributes handbills or performs the assistance including route guidance. Examples of the predetermined conditions are age, sex, and costume. Moreover, the activation of a predetermined device may be other actions.

First, for the farm products grown in the imaging target area 3, the portable terminal 100 transmits a plurality of the image data of the farm products for determining the appropriate harvest time to the wireless aircraft 10 (step S01). The wireless aircraft 10 stores the image data transmitted from the portable terminal 100. In step S01, the portable terminal 100 acquires the image data of the farm products for determining the appropriate harvest time and transmits it through the public line network such as the Internet. Moreover, in step S01, the portable terminal 100 may take an image of the farm products for determining the appropriate harvest time using the imaging device such as a camera installed in the portable terminal 100, and transmit the taken image data to the wireless aircraft 10. Moreover, the image data acquired by other methods may be transmitted to the wireless aircraft 10. Furthermore, the number of the image data transmitted from the mobile terminal 100 may be one.

The portable terminal 100 transmits the imaging instruction to the imaging target area 3 to the wireless aircraft 10 (step S02). In step S02, the location information of the imaging target area 3 is included in the imaging instruction. In step S02, the portable terminal 100 may directly instruct the location information of the imaging target area 3, or instruct through other applications, etc., such as map application, or otherwise instruct the location information acquired through the public line network.

The wireless aircraft 10 may move to the imaging target area 3 based on the location information of the imaging target area 3 included in the imaging instruction and take the live image of the farm products (step S03). In step S03, the wireless aircraft 10 may move to the imaging target area 3 based on the location information of imaging target area 3 that was previously programming into it and take the live image of the farm products. In step S03, the wireless aircraft 10 takes the live image of the farm products.

The wireless aircraft 10 takes an image of the farm product a, and simultaneously detects and acquires its own location information from the GPS system 5 (step S04). More specifically, the wireless aircraft 10 takes the live image of the farm product a, and simultaneously detects and acquires its own location information from the GPS system 5.

The wireless aircraft 10 compares the live image of the farm products with the stored image data of the farm products for determining the appropriate harvest time (step S05). In step S05, the wireless aircraft 10 performs image analysis on the stored image data and identifies the size, shape, color, and irregularity, etc., of the farm products for determining the appropriate harvest time. The wireless aircraft 10 also performs image analysis on the taken live image data and identifies the size, shape, color, and irregularity, etc., of the farm products in the live image data. The wireless aircraft 10 judges whether or not the size, shape, color, and irregularity, etc., of the farm products identified in the stored image data are similar to the same identified in the live image data. In step S05, to determine whether or not the size, shape, color, and irregularity, etc. are similar, each of the size, shape, color, and irregularity, etc., is extracted as the feature amount from the stored image data and the taken live image data, compared separately, and judged if each of them is near or equal, respectively.

In step S05, if judging that the taken live image data is similar to the stored image data, the wireless aircraft 10 associates and stores the harvest information showing that the farm products in the taken live image can be harvested with the location information of the taken live image (step S06).

On the other hand, in step S05, if judging that the taken live image data is not similar to the stored image data, the wireless aircraft 10 judges whether or not pests or diseases exist (step S07). In step S07, the wireless aircraft 10 performs image analysis on the stored image data and identifies the shape, color, and irregularity, etc., of the farm products for determining the appropriate harvest time. The wireless aircraft 10 also performs image analysis on the image data of the taken live image and identifies the shape, color, and irregularity, etc., of the farm products in the live image. The wireless aircraft 10 judges whether or not the shape, color, and irregularity, etc., of the farm products identified in the stored image data is different from the same identified in the live image data. To determine whether or not the shape, color, and irregularity, etc., is different, each of the shape, color, and irregularity, etc., is extracted as the feature amounts from the stored image data and the taken live image data respectively, compared separately, and judged if each of them is different, respectively.

In step S07, if judging that the taken live image data is matched with the stored image data, the wireless aircraft 10 judges that no pests and diseases exist, and associates and stores the countermeasure unnecessary information showing that it is not necessary to take countermeasure with the location information of the taken live image (step S08).

On the other hand, in step S07, if judging that the taken live image data is not matched with the stored image data, the wireless aircraft 10 judges that pests or diseases exist and associates and stores the countermeasure information showing that it is necessary to take countermeasure with the location information of the taken live image (step S09). The wireless aircraft 10 executes the imaging instruction processes on and after step S03 for other farm products.

After executing processes in steps S03 to S09 for all the farm products a-p, the wireless aircraft 10 transmits the harvest information, countermeasure information, countermeasure unnecessary information, and location information on the farm products to the portable terminal 100 (step S10).

Based on the received harvest information, countermeasure information, countermeasure unnecessary information, and location information on the farm products, the portable terminal 100 generates and displays the farm products map showing that the farm products can be harvested, or it is necessary to perform the predetermined countermeasure against the pests and diseases (step S11).

### Configuration of the Location Information Output System 1

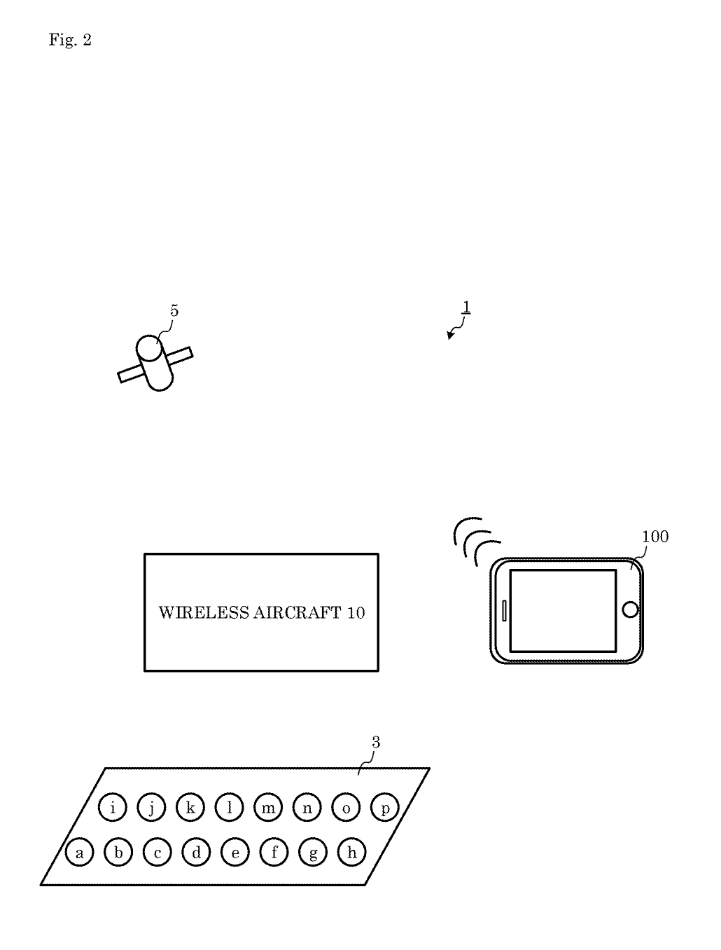

FIG. 2 shows a configuration diagram of the location information output system 1 according to a preferable embodiment of the present invention. The location information output system 1 includes an imaging target area 3, a GPS system 5, a wireless aircraft 10, and a portable terminal 100.

Wireless aircraft 10 has functions to be described later and a capability of data communication, which flies in the air with propeller of its own. Moreover, the wireless aircraft 10 is a wireless aircraft which is capable of remote control from an external terminal such as the portable terminal 100 or other operational terminals, and automatic control based on the predetermined action which is programmed in it.

The wireless aircraft 10 includes a camera, etc., that takes moving and still images of the imaging target area 3 as a live image. Moreover, the wireless aircraft 10 detects and acquires its own location information of the current location from the GPS system 5. Moreover, the wireless aircraft 10 includes a memory unit that stores a specific image of the extracted object. Examples of the extracted objects are farm products and a person. Examples of the specific image of the extracted objects are size, shape, color, and irregularity in case of a farm product, and age, sex, and costume in case of a person. Moreover, the wireless aircraft 10 compares a live image with a specific image to recognize an object to be extracted from the live image. The objects to be extracted are size, shape, color, and irregularity of the farm products, or age, sex, and costume of the person included in the live image. The wireless aircraft 10 includes the data communication functions that transmit the location information of its own acquired from the GPS system 5 to the portable terminal 100 when it has recognized the object. Moreover, the wireless aircraft 10 includes a device activating unit that activates a predetermined device according to the type of the specific image when moved back to the previous location in which the location information was output. The activation of the predetermined device is a chemical spraying for exterminating the pests and diseases in case of the farm products and is a distribution of handbills depending on the sex or assistance including route guidance in case of a person.

The user terminal 100 is a home or an office appliance with a data communication function and performing a data communication with the wireless aircraft 10. Examples of the mobile terminal 100 include information appliances such as a mobile phone, a mobile terminal, a personal computer, a net book terminal, a slate terminal, an electronic book terminal, and a portable music player.

The GPS system 5 is a general GPS system that transmits the location information of the wireless aircraft 10 to the wireless aircraft 10 based on the request by the wireless aircraft 10.

The imaging target area 3 is a place such as a field where farm products are grown. In the imaging target area 3, two or more of the farm products a-p are grown. The number of the farm products grown in the imaging target area 3 is not limit to the number of this embodiment and may be more or less than the number of this embodiment. The imaging target area 3 may be a place such as a road or a facility where a person or a vehicle, etc., exists or may be other places.

### Functions

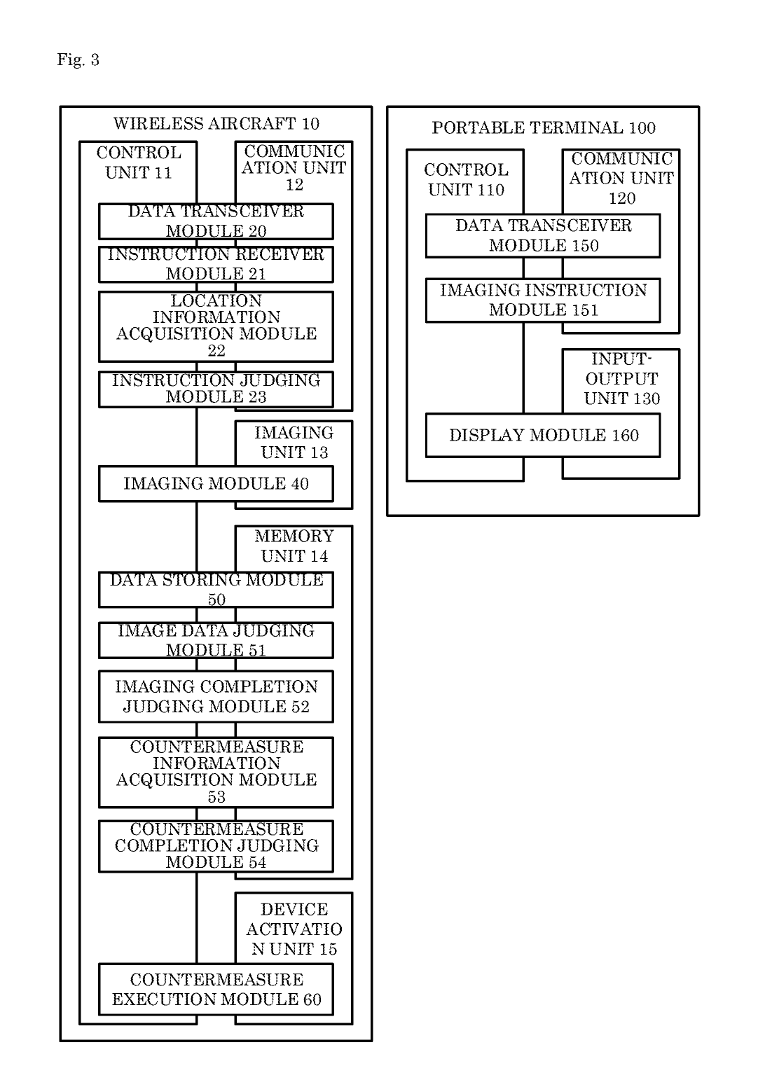

The structure of each device will be described below with reference to FIG. 3.

The wireless aircraft 10 includes a control unit 11 such as a central processing unit (hereinafter referred to as “CPU”), random access memory (hereinafter referred to as “RAM”), and read only memory (hereinafter referred to as “ROM”) and a communication unit 12 such as a device capable of communicating with other devices, for example a Wireless Fidelity or Wi-Fi® enabled device complying with IEEE 802.11. Moreover, the communication unit 12 is provided with a device for Near Field Communication such an IR communication, a device to send and receive radio wave of predetermined bandwidth, and a device to acquire its own location information from the GPS system 5.

The wireless aircraft 10 also includes an imaging unit 13 that takes an image, for example, a camera.

The wireless aircraft 10 also includes a memory unit 14 such as a hard disk, a semiconductor memory, a record medium, or a memory card to store data. The memory unit 14 includes the function that stores the image data of the moving and still images, etc., taken by the imaging unit 13 of the wireless aircraft 10 described later. The memory unit 14 also includes the function that stores the image data of the farm products received from the portable terminal 100. Moreover, the memory unit 14 includes the function that stores the program for activating the predetermined device. Furthermore, the memory unit 14 includes the image data table, location information table, and countermeasure information table described later.

Moreover, the wireless aircraft 10 is provided with a device activation unit 15 to maintain and spray agricultural chemicals and to harvest and store the farm products.

In the wireless aircraft 10, the control unit 11 reads a predetermined program to run a data transceiver module 20, an instruction receiver module 21, a location information acquisition module 22, and an instruction judging module 23 in cooperation with the communication unit 12. Moreover, in the wireless aircraft 10, the control unit 11 reads a predetermined program to run an imaging module 40 in cooperation with the imaging unit 13. Furthermore, in the wireless aircraft 10, the control unit 11 reads a predetermined program to run a data storing module 50, an image data judging module 51, an imaging completion judging module 52, a countermeasure information acquisition module 53, and a countermeasure completion judging module 54 in cooperation with the memory unit 14. Yet still furthermore, in the wireless aircraft 10, the control unit 11 reads a predetermined program to run a countermeasure execution module 60 in cooperation with the device activation unit 15.

The mobile terminal 100 includes a control unit 110 including a CPU, a RAM, and a ROM; and a communication unit 120 including a Wireless Fidelity or Wi-Fi® enabled device complying with, for example, IEEE 802.11, or a Near Field Communication such as IR communication enabled device, and a device for transmitting the radio wave of a predetermined bandwidth enabling the communication with other devices in the same way as the wireless aircraft 10.

The portable terminal 100 also includes an input-output unit 130 including a display unit outputting and displaying data and images that have been processed by the control unit 110; and an input unit such as a touch panel, a keyboard, or a mouse that receive an input from a user. The mobile terminal 100 also includes a device capable of acquiring location information, such as a GPS system 5, a device such as a camera capable of taking an image and a device displaying the farm products map described later.

In the portable terminal 100, the control unit 110 reads a predetermined program to run a data transceiver module 150 and an imaging instruction module 151 in cooperation with the communication unit 120. Still furthermore, in the portable terminal 100, the control unit 110 reads a predetermined program to run a display module 160 in cooperation with the input-output unit 130.

### Location Information Output Process

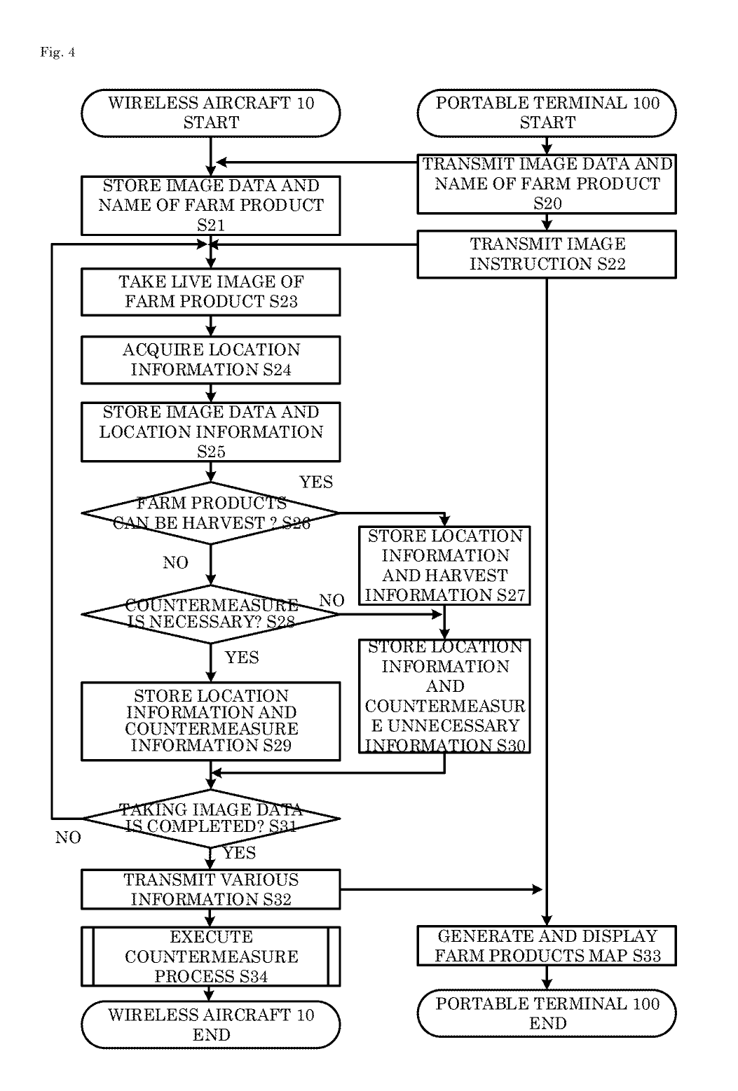

FIG. 4 is a flow chart of the location information output process executed by the wireless aircraft 10 and the portable terminal 100. The tasks executed by the modules of each of the above-mentioned units will be explained below together with this process.

First, the data transceiver module 150 of the portable terminal 100 transmits the image data of the farm products for determining the appropriate harvest time and the name of the farm products which are grown in the imaging target area 3 to the wireless aircraft 10 (step S20). In step S20, the data transceiver module 150 acquires the image data of the farm products for determining the appropriate harvest time for the farm products through the public line network such as the Internet, and transmits the acquired image data and the name of the farm products to the wireless aircraft 10. In step S20, the data transceiver module 150 may take an image of the farm products for determining the appropriate harvest time using the imaging device such as a camera installed in the portable terminal 100, and transmit the taken image data and the name of the farm products to the wireless aircraft 10. Moreover, the data transceiver module 150 may obtain an image data of the farm products for determining the appropriate harvest time of the farm products which is acquired by the other methods and the name of the farm products, and transmit the acquired image data to the wireless aircraft 10. Moreover, the number of the image data that the data transceiver module 150 transmits may be one, or more than one.

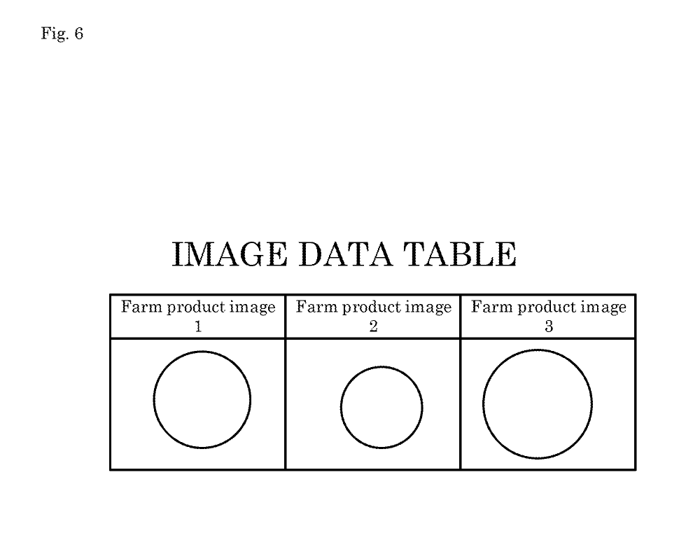

The data transceiver module 20 of the wireless aircraft 10 receives the image data transmitted from the portable terminal 100. The data storing module 50 of the wireless aircraft 10 stores the received image data in the image data table shown in FIG. 6 (step S21).

### Image Data Table

FIG. 6 shows the image data table that the data storing module 50 of the wireless aircraft 10 stores. The data storing module 50 associates and stores the received image data with the name of the farm products. In this embodiment, the name of the farm products that the data storing module 50 stores is “Farm product A”. Moreover, the image data that the data storing module 50 stores is the image data of the farm products for determining the appropriate harvest time of the Farm product A. The data storing module 50 associates and stores two or more image data with a Farm product A.

The image data that the data storing module 50 of the wireless aircraft 10 stores may be not limited to more than one and may be one. Moreover, the number of the image data that the data storing module 50 stores is not limited to 3 but may be 2, 4 or more. Moreover, one or two or more image data for each different kind of farm products may be stored. Moreover, the image data stored in the data storing module 50 is not limited to an image but it only has to be data for judging an image such as size, color, shape, or irregularity, and may be other type of data such as character or symbolic data.

Next, the imaging instruction module 151 of the portable terminal 100 transmits the imaging instruction of the imaging target area 3 to the wireless aircraft 10 (step S22). In step S22, location information of the imaging target area 3 and the place of the farm products are included in the imaging instruction transmitted from the imaging instruction module 151. In step S22, the location information of the imaging target area 3 and the location information of each farm products which is included in the imaging instruction transmitted from the imaging instruction module 151 may be input directly by a user, or input through other applications, etc., such as map application, or otherwise input through the public line network.

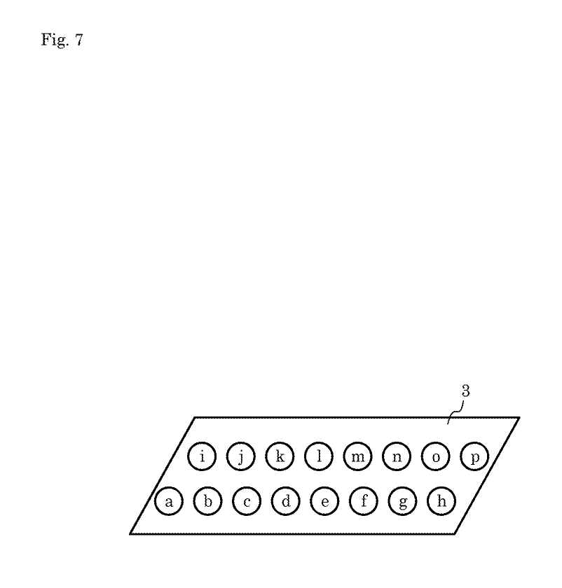

The instruction receiver module 21 of the wireless aircraft 10 receives the imaging instruction transmitted from the portable terminal 100. The imaging module 40 of the wireless aircraft 10 moves to the imaging target area 3 shown in FIG. 7 based on the information on the imaging target area 3 and the place of the farm products that are included in the imaging instruction and takes the live image of the farm products a-p (step S23). In step S23, the wireless aircraft 10 may move to the imaging target area 3 based on the information on the imaging target area 3 and the place of the farm products which is previously programmed in it and take the live image of the farm products. Whenever taking an image of the live image of one of the farm products, the wireless aircraft 10 executes the following process.

FIG. 7 shows an imaging target area 3. As mentioned above, two or more of the farm products a-p are grown in the imaging target area 3.

The imaging module 40 takes the live image of the farm products a, and simultaneously the location information acquisition module 22 of the wireless aircraft 10 detects and acquires its own location information from the GPS system 5 (step S24). More specifically, in step S24, the location information acquisition module 22 acquires its own location information on which the live image is taken from the GPS system 5.

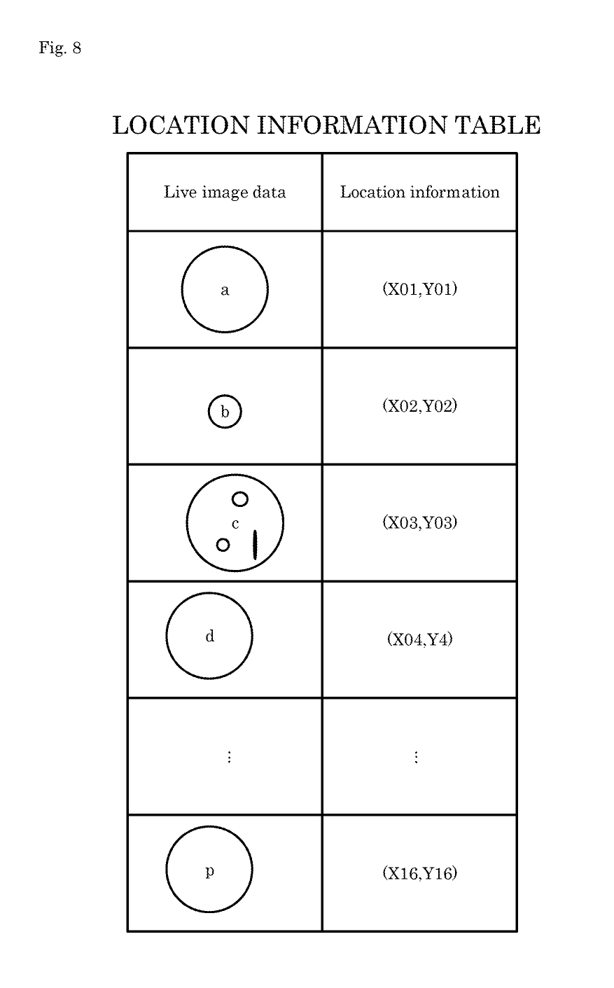

The data storing module 50 of the wireless aircraft 10 associates and stores the live image taken by the imaging module 40 with the location information of the taken live image acquired by the location information acquisition module 22 in the location information table shown in FIG. 8 (step S25).

### Location Information Table

FIG. 8 shows a location information table that the data storing module 50 of the wireless aircraft 10 stores. The data storing module 50 associates and stores the live image taken by the imaging module 40 with the location information acquired by the location information acquisition module 22. The data storing module 50 associates and stores each image data of the farm products a-p taken by the imaging module 40 with each location information of the farm products a-p.

The number of the image data that the data storing module 50 of the wireless aircraft 10 stores is not limit to the number of this embodiment and may be more or less than the number of this embodiment. Moreover, the image data stored in the data storing module 50 is not limited to an image but it only has to be data such as size, color, shape, or irregularity for judging an image, and may be other type of data such as character or symbolic data. Moreover, the location information that the data storing module 50 stores is not limited to the embodiment of the present invention but may be stored by north latitude and east longitude, or by latitude and longitude, or otherwise by other methods.

The image data judging module 51 of the wireless aircraft 10 compares the live image data of the farm products that the data storing module 50 stored with the stored image data of the farm products for determining the appropriate harvest time that the data storing module 50 stores and judges whether or not the farm products of the live image can be harvested (step S26). In step S26, the image data judging module 51 performs image analysis on the image data of the farm products for determining the appropriate harvest time, and identifies the shape, color, and irregularity, etc., as the feature amounts that are appropriate for harvest. Additionally, the image data judging module 51 performs image analysis on the stored live image of the farm products, and identifies the size, shape, color, and irregularity, etc., as the feature amounts. The image data judging module 51 judges whether or not the size, shape, color, and irregularity, etc., extracted from the stored image data of the farm products for determining the appropriate harvest time is similar to the same extracted from the live image of the farm products, and determine whether or not the farm products of the live image can be harvested. In step S26, to determine whether or not the size, shape, color, and irregularity, etc., are similar, the image data judging module 51 compares the size, shape, color, irregularity of the stored and live image data separately and judges if they are near or equal, respectively.

The image data judging module 51 may judge whether or not the stored image data and the taken live image data are similar based on whether or not any one of the size, shape, color, or irregularity, etc., is near or equal, or two or more than two of such feature amounts are near or equal. Moreover, the image data judging module 51 may extract other feature amounts other than the size, shape, color, and irregularity, to judge whether or not the stored image data and the taken live image data are similar.

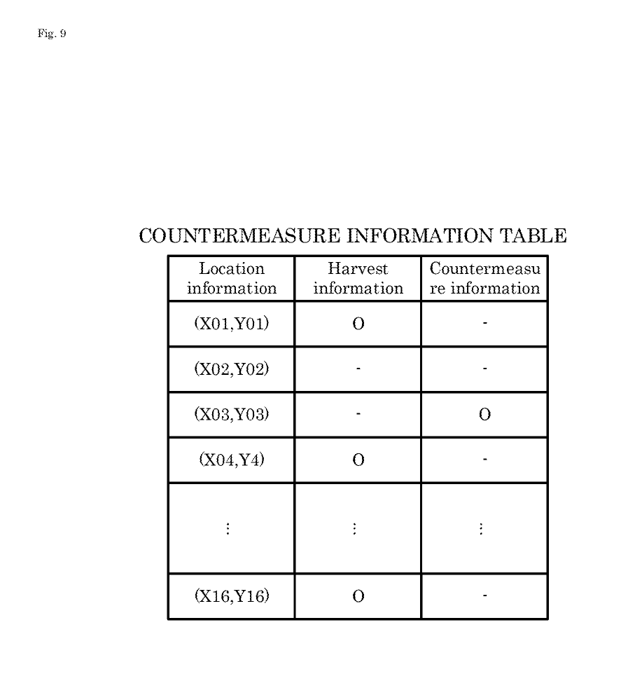

In step S26, the image data judging module 51 of the wireless aircraft 10 judges that the taken live image data is similar to the stored image data of the farm products for determining the appropriate harvest time (YES), the data storing module 50 associates and stores the location information of the taken live image with the harvest information showing that the farm products can be harvested in the countermeasure information table shown in FIG. 9 described later (step S27).

In step S27, the data storing module 50 of the wireless aircraft 10 may previously acquire and store the information on the growth of the farm products. The information on the growth of the farm products is, for example, the information on the amount of growth of the size and shape for each day or the period from the germination to the harvest becomes possible. The image data judging module 51 may calculate the period until the harvest of the farm products becomes possible from the state of the taken live image data based on the stored information on the growth, and the data storing module 50 may store the calculated period as the harvest information.

On the other hand, in step S26, if judging that the taken live image data is not similar to the stored image data of the farm products for determining the appropriate harvest time (NO), the image data judging module 51 of the wireless aircraft 10 compares the live image data of the farm products that the data storing module 50 stores with the stored image data of the farm products for determining the appropriate harvest time that the data storing module 50 stores to judge whether or not a countermeasure against the pests or diseases, etc., is necessary for the farm products of the live image data (step S28). In step S28, the image data judging module 51 perform the image analysis on the image data of the farm products for determining the appropriate harvest time and identifies the shape, color, and irregularity, etc., as the feature amounts. Additionally, the image data judging module 51 performs image analysis on the stored live image of the farm products and identifies the shape, color, and irregularity, etc., as the feature amounts. The image data judging module 51 judges whether or not the feature amounts such as shape, color, and irregularity extracted from the stored image data of the farm products for determining the appropriate harvest time are different from the same extracted from the live image data of the farm products and determines whether or not a countermeasure against the pests or diseases, etc., is necessary for the farm products of the live image data. In step S27, to determine whether or not the shape, color, and irregularity, etc., are different, the image data judging module 51 compares the color or irregularity and judges if the stored image data and the taken live image data are different.

In step S28, the image data judging module 51 may acquire the image data of the pests or diseases from the portable terminal 100, a database, etc., perform the image analysis on the acquired image data, identify the shape, color, and irregularity, etc., as the feature amounts, and judge whether or not pests or diseases exist by comparing with the shape, color, and irregularity, etc., extracted from the live image data. Moreover, the image data judging module 51 may judge that a countermeasure against the pests or diseases, etc., is necessary in case that all of the feature amounts or any of the 2 feature amounts among from the shape, color, and irregularity, etc., are different. Furthermore, the image data judging module 51 may extract other feature amounts other than the shape, color, and irregularity to judge the similarity. In this case, the image data judging module 51 may judge whether or not a countermeasure is necessary based on whether or not all, a plural of, or any of the extracted feature amounts are different for the stored image data and the live image data.

In step S28, if the image data judging module 51 of the wireless aircraft 10 judges that the live image data and the stored image data of the farm products for determining the appropriate harvest time is different (YES), the data storing module 50 associates and stores the location information of the taken live image with the countermeasure information showing that a countermeasure is necessary for the farm products in the countermeasure information table shown in FIG. 9 described later (step S29).

On the other hand, in step S28, the image data judging module 51 of the wireless aircraft 10 judges that the live image data and the stored image data of the farm products for determining the appropriate harvest time is not different (NO), the data storing module 50 associates and stores the location information of the taken live image with the countermeasure unnecessary information showing that no countermeasure is necessary for the farm products in the countermeasure information table shown in FIG. 9 described later (step S30).

### Countermeasure Information Table

FIG. 9 shows a countermeasure information table that the data storing module of the wireless aircraft 10 stores. The data storing module 50 associates and stores the location information of the image taken by the imaging module 40 with the harvest information showing whether or not the farm products grown in this location can be harvested and the countermeasure information showing whether or not a countermeasure is necessary for the farm products grown at this location. In FIG. 9, the location information “(X01,Y01)” of the farm product a, is associated and stored with the harvest information “0” and the countermeasure information “-”. For other farm products b-p, the location information is also associated and stored with the harvest information and the countermeasure information. In this embodiment, the “O” mark in item “Harvest information” shows that the farm products grown in the location information associated with this harvest information is appropriate for harvest. The “-” mark in item “Harvest information” shows that the farm products grown in the location information associated with this harvest information is not appropriate for harvest. The “O” mark in item “Countermeasure information” shows that a countermeasure against the pests or diseases, etc., is necessary for the farm products grown in the location information associated with this countermeasure information. The “-” mark in item “Countermeasure information” shows that a countermeasure against the pests or disease, etc., is not necessary for the farm products grown in the location information associated with this countermeasure information.

The number of the items of the countermeasure information table stored by the data storing module 50 of the wireless aircraft 10 is not limited to the embodiment of the present invention, and other items may be added or any of the items may be deleted. Moreover, the harvest information stored by the data storing module 50 may be any information other than “O” or “-”. Furthermore, the countermeasure information stored by the data storing module 50 may be any information other than “O” and “-”. For example, as described above, the data storing module 50 may store the remaining number of the days until the harvest becomes possible as the harvest information or the necessary chemical as the countermeasure information.

The imaging completion judging module 52 of the wireless aircraft 10 judges whether or not taking images of all the farm products a-p in the imaging target area 3 is completed (step S31). In step S31, the imaging completion judging module 52 judges whether or not the location information, the harvest information, and the countermeasure information on all the farm products a-p is stored in the countermeasure information table.

If judging that any of the location information, harvest information, or countermeasure information for all the farm products a-p is not stored, the imaging completion judging module 52 of the wireless aircraft 10 judges that taking images of all the farm products a-p in the imaging target area 3 is not completed (step S31 NO) and repeats the processes in steps S23 to S30 mentioned above until the imaging module 40 completes taking the live image data of all the farm products a-p.

On the other hand, if judging that the location information, harvest information, and countermeasure information on all the farm products a-p is stored, the imaging completion judging module 52 of the wireless aircraft 10 judges that taking images of all the farm products a-p in the imaging target area 3 is completed (step S31 YES), and the data transceiver module 20 transmits the location information, harvest information, and countermeasure information on each farm product stored in the countermeasure information table to the portable terminal 100 (step S32).

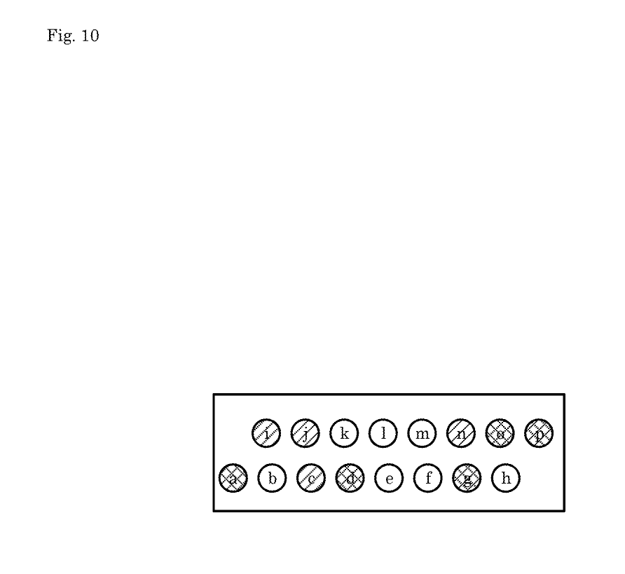

The data transceiver module 150 of the portable terminal 100 receives the location information, harvest information, and countermeasure information on each farm product that the wireless aircraft 10 transmits. The display module 160 of the portable terminal 100 displays the farm products map shown in FIG. 10 based on the received information (step S33).

### Farm Products Map

FIG. 10 shows a farm products map that the display module 160 of the portable terminal 100 displays. The display module 160 displays the place of each farm products a-p in the imaging target area 3 based on the received location information of the farm products a-p. Moreover, the display module 160 displays each farm products a-p using display mode to show that the farm products a-p can be harvested, a countermeasure is necessary, or the harvest is not possible and no countermeasure is necessary, respectively. In FIG. 10, the display module 160 displays by hatching as display mode to show that targeted farm products can be harvested. Moreover, in FIG. 10, the display module 160 displays by any hatching other than the hatching used for the farm products that can be harvested as display mode to show that a countermeasure is necessary for the targeted farm products. Furthermore, in FIG. 10, the display module 160 displays by void as display mode to show that the targeted farm products cannot be harvested and no countermeasure is necessary. In the embodiment of the present invention, the farm products a, d, g, o, and p are shown that they can be harvested, the farm products c, i, j, and n are shown that a countermeasure is necessary, and the farm products b, e, f, h, k, l, and m are shown that they don't fall into any category.

The display module 160 displays that the harvest is possible or the countermeasure is necessary by hatching, but may display using display mode such as coloring, shape modifying, and blinking, or by executing the notification by voice, or otherwise by combining with two or more of such display modes.

Next, the countermeasure execution module 60 of the wireless aircraft 10 executes the countermeasure process described later to the farm products for which countermeasure is necessary (step S34).

After executing the countermeasure process, the wireless aircraft 10 terminates the location information output process.

### Countermeasure Process

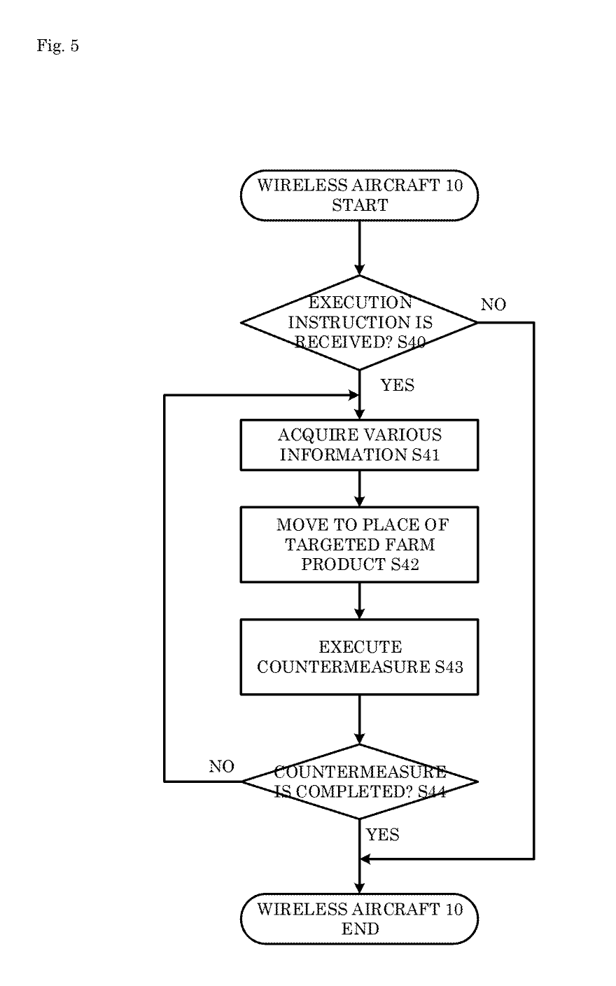

FIG. 5 is a flow chart of the countermeasure process executed by the wireless aircraft 10. The tasks executed by the modules of each of the above-mentioned units will be explained below together with this process.

The instruction judging module 23 of the wireless aircraft 10 judges whether or not the execution instruction of the countermeasure process is received (step S40). In step S40, the instruction judging module 23 judges whether or not the countermeasure instruction is received directly from the portable terminal 100 or from other external terminals or whether or not the countermeasure instruction to the farm products for which countermeasure is necessary is previously included in the predetermined action that is programmed in it.

In step S40, if judging that the execution instruction of the countermeasure process is not received (NO), the instruction judging module 23 of the wireless aircraft 10 ends the process.

On the other hand, in step S40, if the instruction judging module 23 of the wireless aircraft 10 judges that the execution instruction of the countermeasure process is received (YES), the countermeasure information acquisition module 53 of the wireless aircraft 10 acquires the location information, harvest information, and countermeasure information on each farm product that the data storing module 50 stored in the countermeasure information table (step S41).

The wireless aircraft 10 moves to the place of the targeted farm products based on the acquired location information (step S42).

The countermeasure execution module 60 of the wireless aircraft 10 executes countermeasures to the farm products (step S43). In step S43, if the farm products are appropriate for harvest, the countermeasure execution module 60 harvests, retains, and moves the farm products to a predetermined place. Moreover, if pests or diseases exist, the countermeasure execution module 60 sprays a chemical. In step S43, the countermeasure execution module 60 drives the device necessary for the countermeasure and executes necessary countermeasure.

The countermeasure completion judging module 54 of the wireless aircraft 10 judges whether or not countermeasures to all the farm products are completed (step S44). In step S44, the countermeasure completion judging module 54 judges whether or not the movements to all the location information stored in the countermeasure information table are completed.

In step S44, if the countermeasure completion judging module 54 of the wireless aircraft 10 judges that the countermeasure to all the farm products is not completed (NO), the countermeasure execution module 60 repeats the processes on and after step S41 until all the countermeasures to the farm products completes.

On the other hand, in step S44, if judging that the countermeasures to all the farm products are completed (YES), the countermeasure completion judging module 54 of the wireless aircraft 10 ends the countermeasure process.

### Variations

A variation of the invention is described below. The present invention can be applied to, for example, a person other than a farm product. Hereinafter, the following variation is explained as the case applied to a person.

In this variation, the imaging target area is a road or a facility. Moreover, the specific image of the extracted object is an image to identify age, sex, or costume.

The wireless aircraft receives the image data of a specific image through a portable terminal, other external terminals, or public line networks, and stores it. The wireless aircraft receives an imaging instruction of a person based on the predetermined action which is programmed in a portable terminal, in other external terminals, etc., or in it.

The wireless aircraft takes an image of the person who exists in the imaging target area as a live image. Simultaneously, the wireless aircraft acquires the location information of the taken image from the GPS system. The wireless aircraft associates and stores the taken image of the person with the location information of the same.

The wireless aircraft compares the stored specific image data with the live image data to identify person's age, sex, and costume, etc. The wireless aircraft associates and stores the personal data such as age, sex, and costume of the identified person with the location information of the taken image data.

The wireless aircraft transmits the stored location information and the personal data to the portable terminal. The portable terminal generates and displays the congestion map based on the received location information and the personal data. The congestion map displayed by the portable terminal includes, for example, the position of each person that exists in the imaging target area which is shown with an icon or a figure, etc., and the personal data overlapping with the icon or the figure. The congestion map may use other display mode. Moreover, the personal data may be displayed using display mode, in the same way as the embodiment mentioned above, by displaying an icon or figure, etc., with hatching, coloring, shape modifying, and blinking, etc., or by executing the notification by voice, or otherwise by combining with two or more of such display modes. Moreover, the displaying position of the personal data can be changed as appropriate.

When receives the execution instruction of the countermeasure process, the wireless aircraft executes the previously set countermeasure action based on the location information and the personal data of each person. The countermeasure action that a wireless aircraft executes is, for example, a voice guidance for a person of a specific age or distribution of a handbill to a person of a specific sex. A wireless aircraft may execute other countermeasure actions.

Additionally, it should be understood that the variation in the present embodiment is not limited to the example described above and may be other examples.

To achieve the means and the functions that are described above, a computer (including a CPU, an information processor, and various terminals) reads and executes a predetermined program. For example, the program is provided in the form recorded in a computer-readable medium such as a flexible disk, CD (e.g., CD-ROM), or DVD (e.g., DVD-ROM, DVD-RAM). In this case, a computer reads a program from the recording medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

The embodiments of the present invention are described above. However, the present invention is not limited to these embodiments. The effect described in the embodiments of the present invention is only the most preferable effect produced from the present invention. The effects of the present invention are not limited to that described in the embodiments of the present invention.

### REFERENCE SIGNS LIST

3 Imaging target area
5 GPS system
10 Wireless aircraft
100 Portable terminal

What is claimed is:

1. A wireless aircraft flying in the air, comprising:
a camera unit that takes a live image;
a location information detecting unit that detects the location information on which the wireless aircraft is located;
a specific image storage unit that stores a specific image of an extracted object;
an object recognition unit that compares the live image taken by the camera unit with the specific image to recognize an object to be extracted from the live image; and
a location information output unit that outputs the location information detected by the location information detecting unit when the object is recognized.

2. The wireless aircraft according to claim 1, further comprising a device activating unit that activates a predetermined device according to the type of the specific image when the wireless aircraft moves to the position in which the location information was output.

3. A method for outputting the location information performed by the wireless aircraft flying in the air comprising the steps of:
taking a live image;
detecting the location information on which the wireless aircraft is located;
storing a specific image of an extracted object;
comparing the live image taken by the camera unit with the specific image to recognize an object to be extracted from the live image; and
outputting the detected location information when the object is recognized.
